(19) United States
(12) Patent Application Publication
(10) Pub. No.: US 2012/0148760 A1
(43) Pub. Date: Jun. 14, 2012

(54) Induction Heating for Substrate Processing

(76) Inventors: Glen Eric Egami, San Jose, CA (US); Kent Riley Child, Dublin, CA (US)

(21) Appl. No.: 12/963,425

(22) Filed: Dec. 8, 2010

(51) Int. Cl. B05C 13/00; B05D 3/02

(52) U.S. Cl. 427/559; 118/59

(57) ABSTRACT

A system for processing a substrate is provided. The system includes a power source for providing a current, and an RF coil which generates a magnetic field when supplied with the current from the power source. The system further includes a susceptor for supporting the substrate. The susceptor is inductively heated by the magnetic field. The heat from the susceptor is transferred to the substrate so as to heat the substrate.

### BACKGROUND

Deposition processes may require high temperature operations, such as the deposition of graphene. Graphene may be grown by metal-catalyzed chemical vapor deposition (CVD) on metallic substrates such as copper, nickel, platinum, ruthenium, iridium, etc. Typical processing steps include annealing and growth phases at temperatures in the range of about 800 to 1050 degrees Celsius, followed by rapid quenching at cooling rates of about 300 to 600 degrees Celsius per minute.

Common methods of heating include resistive heating and infrared (IR) lamp heating. Resistive heating requires a heating element embedded in a metal or ceramic pedestal. However, the pedestal has a high thermal mass which makes rapid heating and cooling of the pedestal difficult. Heat rejection for such a mass further makes heating to high temperatures inefficient. Additionally, the thermal expansion and high stresses imposed on the pedestal may not permit heating of the pedestal to high target temperatures. Rapid cooling of the pedestal requires a complicated cooling circuit to provide adequate temperature changes and control.

Heating by IR lamps enables use of a lower target thermal mass than with resistive heating, and thereby facilitates faster temperature ramp up and ramp down times. However, IR lamps are subject to numerous inefficiencies which become increasingly problematic at high temperatures such as those required for graphene deposition. Energy losses occur due to inefficiency in reflectors, and during cooling of the lamps. Additionally, energy losses to the chamber body, lid, and process gases are high due to stray radiation.

It is in this context that embodiments of the invention arise.

### SUMMARY

Embodiments of the present invention provide a system and method for processing a substrate. According to embodiments of the invention, a susceptor configured to support a substrate is inductively heated. As the susceptor is heated, the heat is transferred to the substrate, which is in turn heated by the susceptor. Several inventive embodiments of the present invention are described below.

In one aspect of the invention, a system for processing a substrate is provided. The system includes a power source for providing a current, and a radio frequency (RF) coil, the RF coil generating a magnetic field when supplied with the current. Furthermore, the system includes a susceptor for supporting the substrate, the susceptor being inductively heated by the magnetic field so as to heat the substrate. In one embodiment, the RF coil is formed as a planar spiral. In one embodiment, the system includes a lift mechanism for lifting the substrate from the susceptor. The lift mechanism accesses an edge of the substrate via a notch in the susceptor. In one embodiment, the system includes a cooling source for providing a cooling fluid. The RF coil includes an interior channel for enabling the cooling fluid to flow through the RF coil. In one embodiment, the cooling fluid is water.

In one embodiment, a method of preparing a substrate is provided. According to the method, a substrate is oriented over a susceptor. Then, a magnetic field is generated which inductively heats the susceptor. The heat from the susceptor is transferred to the substrate so as to heat the substrate. In one embodiment, the magnetic field is generated by applying a current to an RF coil disposed beneath the susceptor. The RF coil is formed as a planar spiral oriented along a plane parallel to the top surface of the susceptor.

Other aspects of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings. Like reference numerals designate like structural elements.

FIG. 1A illustrates a cross-sectional perspective view of a system for processing a substrate, in accordance with an embodiment of the invention.

FIG. 1B illustrates a simplified circuit diagram illustrating the functional components of the system, in accordance with an embodiment of the invention.

FIG. 2 illustrates an RF coil formed as a planar spiral, in accordance with an embodiment of the invention.

FIG. 3A illustrates a cooling mechanism for a system for processing a substrate, in accordance with an embodiment of the invention.

FIG. 3B illustrates a system for processing a substrate, in accordance with an embodiment of the invention.

FIGS. 4A and 4B illustrate top and bottom perspective views of a system for processing a wafer, in accordance with an embodiment of the invention.

FIG. 5A illustrates a system for processing a substrate, in accordance with an embodiment of the invention.

FIG. 5B illustrates a cross-section of a portion of the RF coil of the system of FIG. 5A, in accordance with an embodiment of the invention.

FIG. 6A illustrates a top view a system for processing a substrate, in accordance with an embodiment of the invention.

FIG. 6B illustrates a cross-section view of the system of FIG. 6A, in accordance with an embodiment of the invention.

FIG. 7 illustrates a system for processing one or more substrates, in accordance with an embodiment of the invention.

### DETAILED DESCRIPTION

The embodiments described herein provide a method and system for processing a substrate. According to embodiments of the invention, a susceptor is inductively heated by a magnetic field generated from a radio frequency (RF) coil. The heat from the susceptor is transferred to the substrate, thereby heating the substrate. The embodiments of the invention, enable rapid heating of the substrate to high temperatures, as well as rapid cooling of the substrate. It will be obvious, however, to one skilled in the art, that the present invention may be practiced without some or all of these specific details. In other instances, well known process operations have not been described in detail in order not to unnecessarily obscure the present invention.

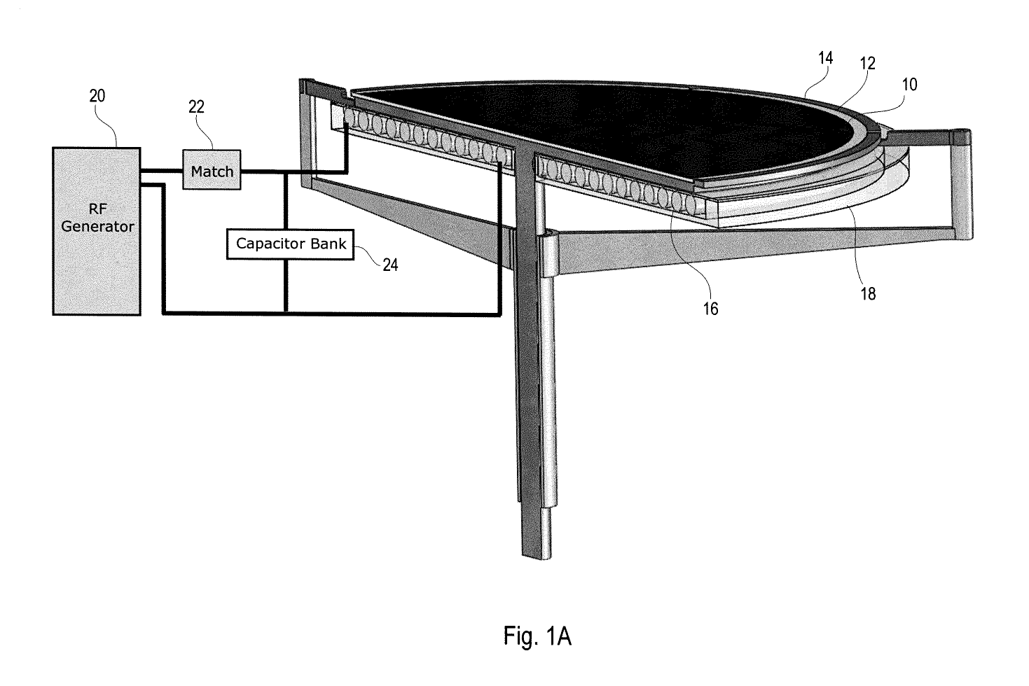

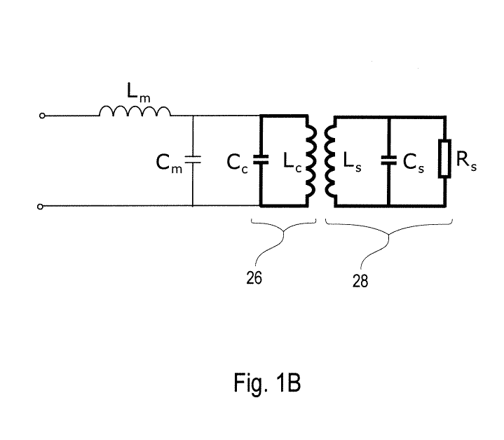

FIG. 1A illustrates a cross-sectional perspective view of a system for processing a substrate, in accordance with an embodiment of the invention. As shown, a substrate 10 and an optional carrier 12 are situated on a susceptor 14. In one embodiment, the susceptor 14 is configured to rotate, thereby rotating the substrate 10. In another embodiment, the susceptor 14 is configured to be stationary. A coil 16 is supported in a coil matrix 18. When supplied with a current, the coil 16 generates a magnetic field which inductively heats the susceptor 14. The heat from the susceptor 14 is transferred to the substrate 10 so as to heat the substrate 10.

The susceptor 14 may be composed of any material which enables rapid inductive heating to the required temperatures for processing. Preferably, the material provides suitable strength and temperature resistance (low thermal expansion as well as structural integrity over repeated heating and cooling cycles), as well as resistance to chemistries to which the susceptor will be exposed. By way of example, in various embodiments, the susceptor 14 may be composed of materials such as silicon carbide, graphite, tungsten, titanium coated graphite, stainless steel, molybdenum, Iconel, etc. In one embodiment, the susceptor 14 enables rapid inductive heating to temperatures in the range of 600 to 1600 degrees Celsius. The foregoing examples of susceptor materials are provided by way of example only, and not by way of limitation. In other embodiments of the invention, the susceptor may include any type of material which facilitates inductive heating for processing a substrate as herein described.

An RF generator 20 acts as a power source, generating a current which is provided to the coil, which may be referred to as a RF coil. In some embodiments, the RF generator 20 provides power in the range of about 10-50 kilowatts. In other embodiments, the RF generator 20 may provide power of less that 10 kilowatts or greater than 50 kilowatts depending on the process requirement. Furthermore, in some embodiments, the RF generator 20 provides power at a frequency in the range of about 30 hertz to 100 kilohertz. In other embodiments, the frequency may range from about 10 hertz to 100 megahertz. A match network 22 provides impedance matching, while a capacitor bank 24 enables tuning to the resonant frequency of the susceptor 14 to facilitate more efficient inductive heating of the susceptor 14.

FIG. 1B illustrates a simplified circuit diagram illustrating the functional components of the system, in accordance with an embodiment of the invention. The portion 26 represents the RF coil, whereas the portion 28 represents the susceptor. An inductance match Lₘ and capacitance match Cₘ are provided for matching between the RF generator and the RF coil. The RF coil is represented by the portion 26, and has a coil capacitance C_{c} and a coil inductance L_{c}. The susceptor is represented by the portion 28, and has a susceptor inductance Lₛ, a susceptor capacitance Cₛ, and a susceptor resistance Rₛ.

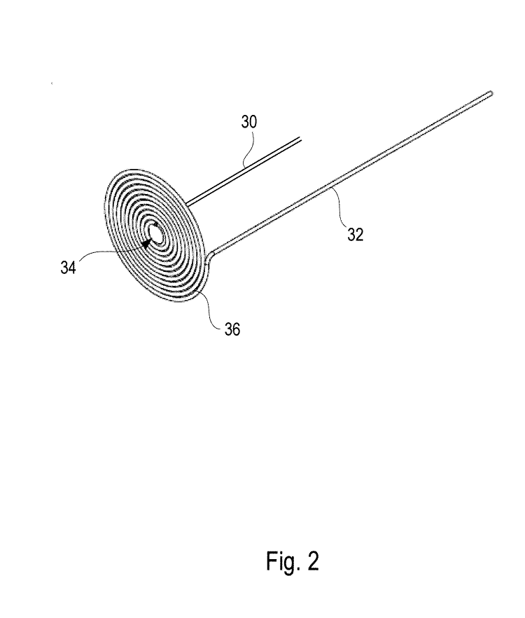

In one embodiment, the RF coil 16 is formed as a planar spiral oriented along a plane parallel to the top surface of the substrate 10. FIG. 2 illustrates an RF coil formed in such a manner, in accordance with an embodiment of the invention. The RF coil includes an RF input terminal 30 and an RF output terminal 32 which connect to the RF generator. In one embodiment, the RF coil has a radius in the range of about 5 to 10 inches. In other embodiments, the RF coil may have a radius of less than 5 inches or greater than 10 inches depending on the process requirements.

The coil 16 includes an inner diameter 34, which does not include any coil structure. The inner diameter 34 enables a shaft to pass through the coil 16 for support purposes as well as possible rotation. In one embodiment, the inner diameter 34 may be between about one and three inches; however, this is not meant to be limiting as diameters less than one inch and greater than three inches may be integrated with the embodiments described herein.

The coil is composed of a conductive hollow tube shaped into a planar spiral. In one exemplary embodiment, the tube has a diameter of about 0.25 to 0.75 inches and is about 0.01 to 0.05 inches thick. It should be appreciated that the tube diameter and thickness is not meant to be limiting. The planar spiral formation of the coil is such that a minimum spacing 36 between adjacent portions of the tube is maintained throughout the spiral. The minimum spacing helps to ensure that the coil does not substantially heat itself during operation, as well as provide uniform heating of the susceptor. In one embodiment, the minimum spacing 36 is about 0.1 to 0.2 inches. In other embodiments, the minimum spacing 36 may be less than 0.1 inches or greater than 0.2 inches.

The coil 16 may be composed of various types of conductive materials, such as copper. The foregoing examples of coil materials are provided by way of example only, and not by way of limitation. In various embodiments, the coil may be composed of any material which provides for adequate generation of a magnetic field to inductively heat the susceptor 14 for substrate processing as described herein.

In one embodiment, the coil includes a protective coating to provide resistance to chemicals to which the coil will be exposed during processing operations. By way of example only, and not by way of limitation, the protective coating may include materials such as nickel, rhodium, silver, etc.

In various embodiments, the system may be configured to promote even heating of the substrate or intentionally differential heating of the substrate. For example, in some embodiments, various properties of the susceptor may be varied. In one embodiment, the thickness of the susceptor may be varied so as to achieve even heating of the susceptor by compensating for inconsistencies in the magnetic field, thereby promoting even heating of the substrate. In another embodiment, the direction of crystallinity of the susceptor material (e.g. graphite) may be varied so as to promote even heating. In still other embodiments, the composition of the susceptor may be varied to promote even heating. Additionally, properties of the coil, such as its shape, thickness, or composition, could be varied so as to promote even heating of the susceptor.

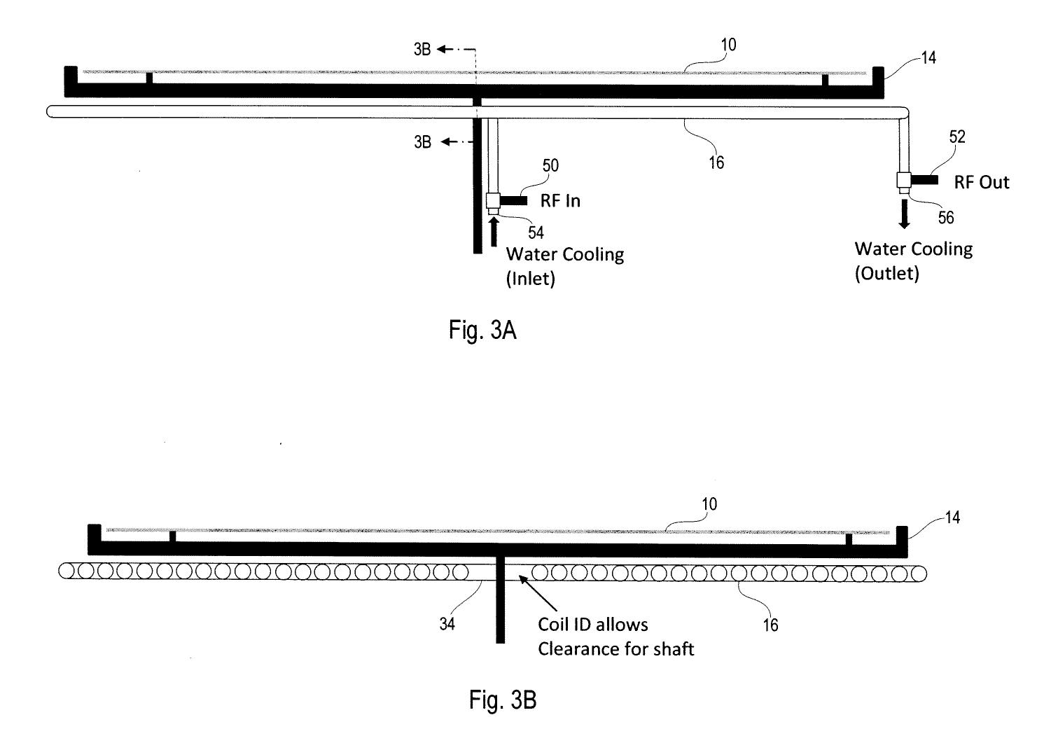

FIG. 3A illustrates a cooling mechanism for a system for processing a substrate, in accordance with an embodiment of the invention. As shown, the substrate 10 is oriented on top of a susceptor 14, which is inductively heated by the magnetic field generated by the RF coil 16 when a current is passed through the coil. The RF coil has an RF input 50 and an RF output 52, for connecting to the RF generator 20. The RF coil 16 consists of a conductive hollow tube which defines an interior channel through which a cooling fluid is flowed. The cooling fluid is provided by a cooling source and is introduced into the interior channel of the RF coil 16 at a fluid input 54, and exits the coil at a fluid output 56. In one embodiment, the cooling fluid is recirculated to the RF coil 16 by a heat exchanger 58. The heat exchanger 58 removes heat from the cooling fluid before introducing it into the RF coil 16. In other embodiments, the cooling fluid may simply be provided to the RF coil 16 by a cooling fluid source, and discarded or otherwise not reused after exiting the RF coil.

In one embodiment, the cooling fluid is water. In other embodiments, the cooling fluid may include any type of fluid (gas or liquid) capable of being utilized to cool the RF coil 16 and transfer heat away from the substrate and susceptor so as to cool both the substrate and the susceptor. The cooling of the RF coil helps to facilitate rapid cool down of the substrate when the inductive heating of the susceptor 14 is stopped (by halting the current flow to the RF coil which stops the generation of the magnetic field). When the heating is stopped, the susceptor rapidly cools, in part due its fairly low thermal mass, thereby cooling the substrate 10 as well. Heat is absorbed by the RF coils, and transferred to the cooling fluid. In one embodiment, the system is configured to provide for cooling rates of the substrate 10 in the range of 300 to 600 degrees Celsius per minute.

FIG. 3B illustrates a cross-section of the system of FIG. 3A, in accordance with an embodiment of the invention. As shown, the substrate 10 is oriented atop the susceptor 14, which is inductively heated by the magnetic field generated by the RF coil 16. The inner diameter 34 of the RF coil 16 provides clearance for a susceptor shaft to pass through the RF coil 16. The susceptor shaft supports the structure of the susceptor 14 above the RF coil 16.

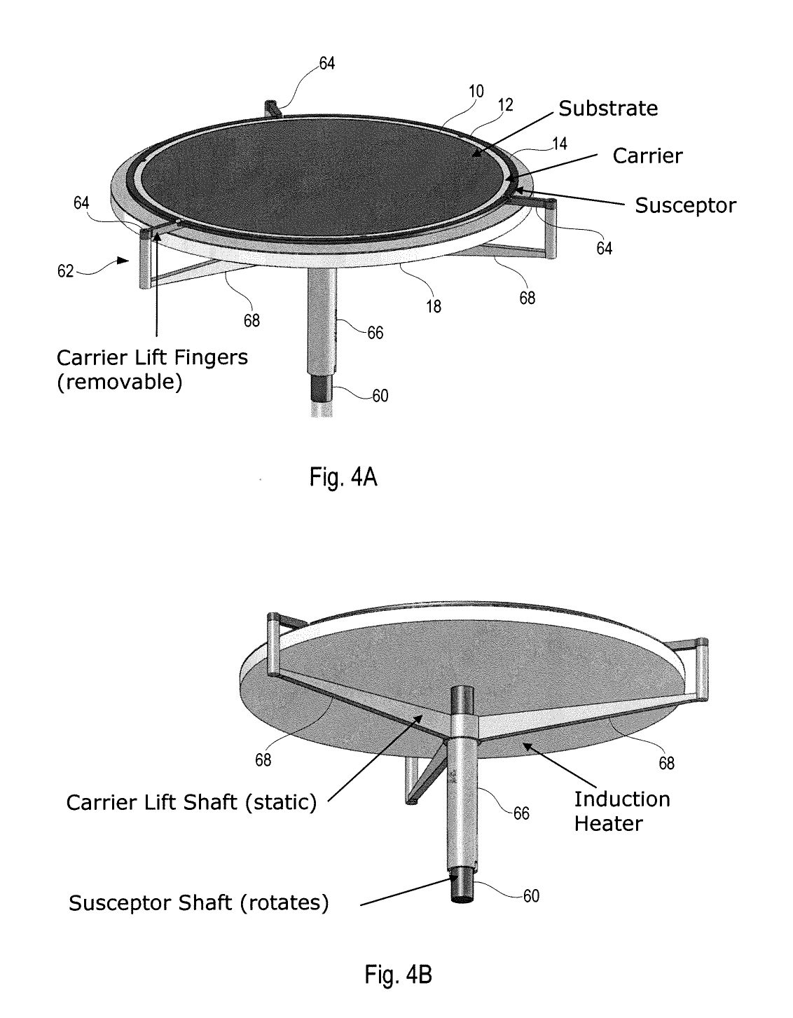

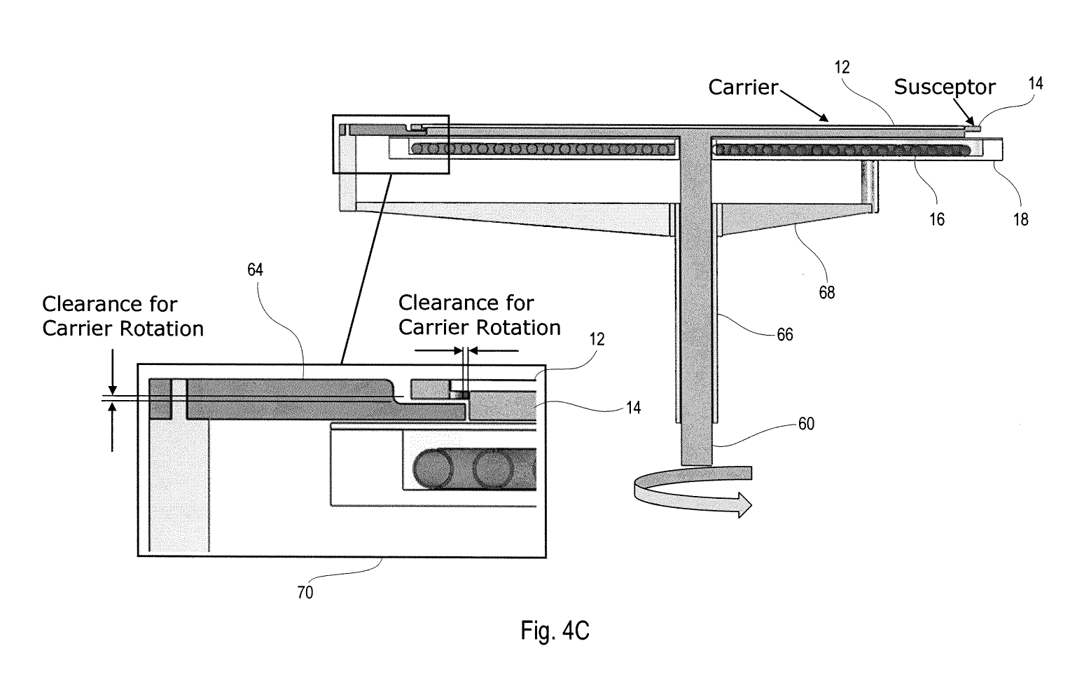

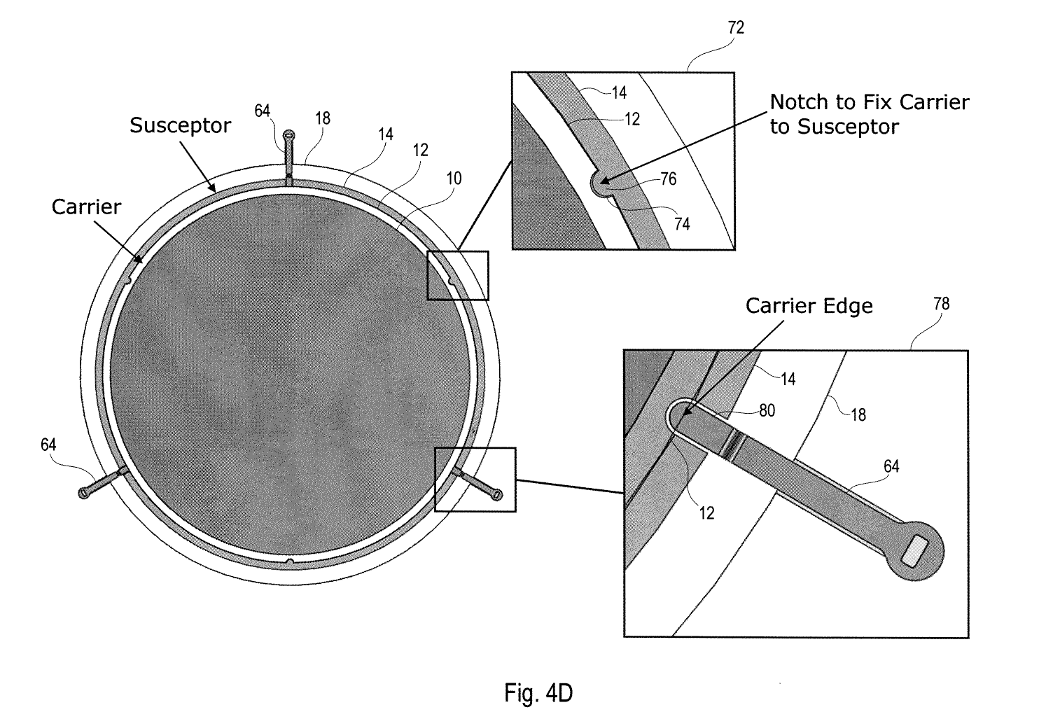

FIGS. 4A and 4B illustrate top and bottom perspective views of a system for processing a wafer, in accordance with an embodiment of the invention. As shown, the substrate 10 is seated in a carrier 14 oriented on top of the susceptor 14. The susceptor 14 is inductively heated by a magnetic field generated by an RF coil contained in the coil matrix 18. As the susceptor 14 is heated and cooled, the substrate 10 is correspondingly heated and cooled. The susceptor 14 is supported from below by a susceptor shaft 60 aligned along the central axis of the susceptor 14, which may be configured to rotate the susceptor 14, and thereby rotate the substrate 10 and carrier 12. By way of example, the rotation may be facilitated by a magnetic liquid rotary seal, such as a Ferrofluidic seal manufactured by the Ferrotec Corporation. In other embodiments, the susceptor shaft 60 is configured to be stationary. The susceptor shaft 60 extends from beneath the RF coil through the inner diameter of the RF coil to support the susceptor 14.

In one embodiment, the susceptor shaft 60 is configured to be raised and lowered, thereby adjusting the distance between the susceptor 14 and the RF coil. As the distance increases, the effect of the magnetic field acting on the susceptor 14 is weakened, whereas the effect of the magnetic field is greater when the distance decreases. By adjusting the distance between the RF coil and the susceptor 14, it is possible to determine an optimal distance range so that the RF coil efficiently heats the susceptor 14 without causing excessive application of the magnetic field to the substrate itself. In an alternative embodiment, the susceptor is supported by an air bearing, so as to float and rotate upon a layer of gas such as a nitrogen or helium. The composition and temperature of the gas flow may also be controlled so as to provide a desired level of heating or cooling.

A lift mechanism 62 is provided for lifting the carrier 12 and the substrate 10 from the susceptor 14. The lift mechanism includes lift members (or fingers) 64 which extend towards the periphery of the carrier 12 and enable lifting of the carrier 12 from its edges. It will be appreciated by those skilled in the art that in embodiments where no carrier is present, the lift members 64 extend towards the periphery of the substrate 10 so as to enable lifting of the substrate 10 from its edges. In one embodiment, the lift mechanism 62 includes a lift shaft 66 surrounding the susceptor shaft 60, and situated below the RF coil. Extending radially from the lift shaft 66 are radial arms 68 which support the lift members 64 that extend inward towards the periphery of the carrier 12 or substrate 10.

FIG. 4C illustrates a cross-sectional view of a system for processing a substrate, in accordance with the embodiment described with reference to FIGS. 4A and 4B. As shown by the expanded view 70, the lift member 64 extends to a position below the carrier 12 so as to be able to lift the carrier 12 from its edge off of the susceptor 14. In some embodiments, the clearances between the lift members and the susceptor 14 may be in the range of 0.010 to 0.050 inches to allow for rotation of the susceptor 14 during heating or cooling operations. In other embodiments, the clearances may be less than 0.010 inches or greater than 0.050 inches. It will be appreciated by those skilled in the art, that in embodiments wherein no carrier is present, the lift members 64 are configured to lift the substrate directly.

FIG. 4D illustrates a top view of a system for processing a substrate, in accordance with the embodiment described with reference to FIGS. 4A, 4B, and 4C. As shown, the substrate 10 is situated in a carrier 12, which is oriented atop the susceptor 14. As shown by the expanded view 72, in one embodiment, the carrier 12 includes a notch 74 which interfaces with a corresponding protuberance 76 of the susceptor 14. The notch 74 and the protuberance 76 enable the carrier 12 to be fixed to the susceptor 14, so that the carrier 12 does not slip when the susceptor 14 is rotated at high rotational speeds.

Additionally, as shown at the expanded view 78, the susceptor 14 also includes notches 80 which permit the lift members 64 to vertically pass through the edges of the susceptor when lifting the carrier 12 from its edges. As shown, the notch 80 extends below the carrier edge, so as to allow access from below to the edge of the carrier 12.

The foregoing embodiment provides for a lift mechanism which accesses and lifts a carrier or substrate from its edges. By lifting the carrier or substrate from its edges, problems associated with lifting the substrate from a more central location beneath the substrate are avoided. For example, lifting the substrate via more centrally located lift pins beneath the substrate may require disrupting the uniformity of the susceptor and the RF coil to accommodate passage of the lift pins or other supporting structures through the susceptor and RF coil to enable access to the underside of the substrate. The present embodiment avoids such problems by accessing and lifting the carrier or substrate from its edges, without requiring passage of any structures through the RF coil or susceptor. It will be appreciated by those skilled in the art that the illustrated embodiment provides merely one example of a lift mechanism for lifting the carrier or substrate from its edges. In other embodiments of the invention, various other lift mechanisms may be utilized which access and lift the substrate or carrier from its edges.

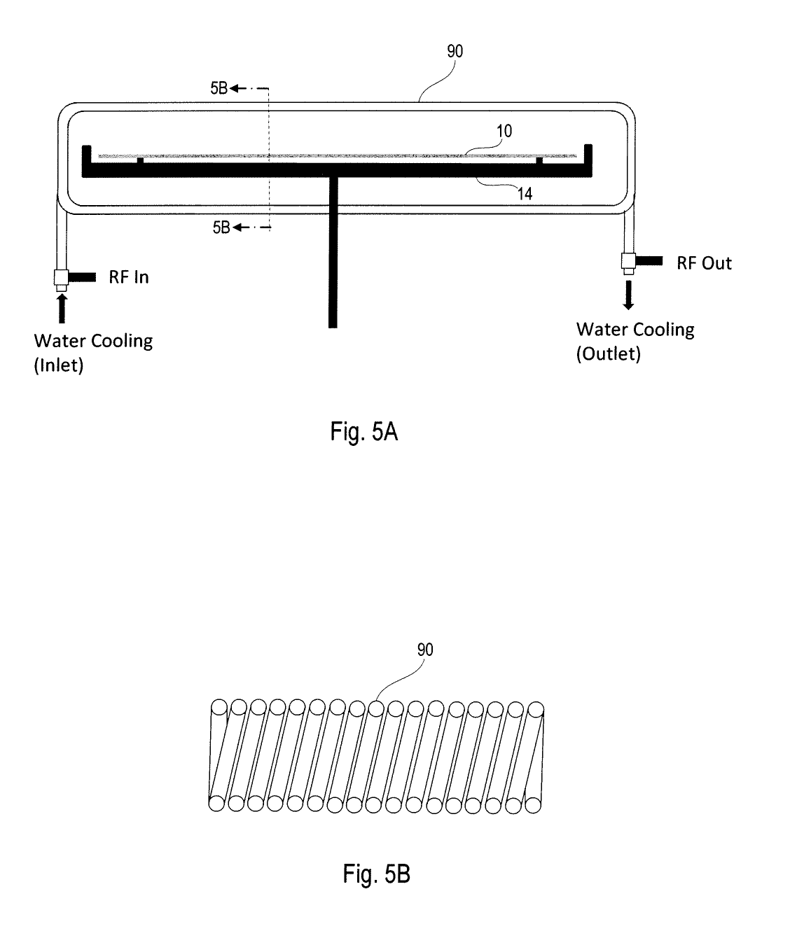

FIG. 5A illustrates a system for processing a substrate, in accordance with an embodiment of the invention. As shown, the susceptor 14 and substrate 10 are situated inside of the RF coil 90. The RF coil 90 passes directly over and beneath the susceptor 14, running parallel to the top and bottom surfaces of the susceptor 14, so as to form a box-like structure with openings at opposite ends, through which the substrate 10 may pass. FIG. 5B illustrates a cross-section of a portion of the RF coil, demonstrating the passage of the coil over both the top and bottom of the susceptor 14.

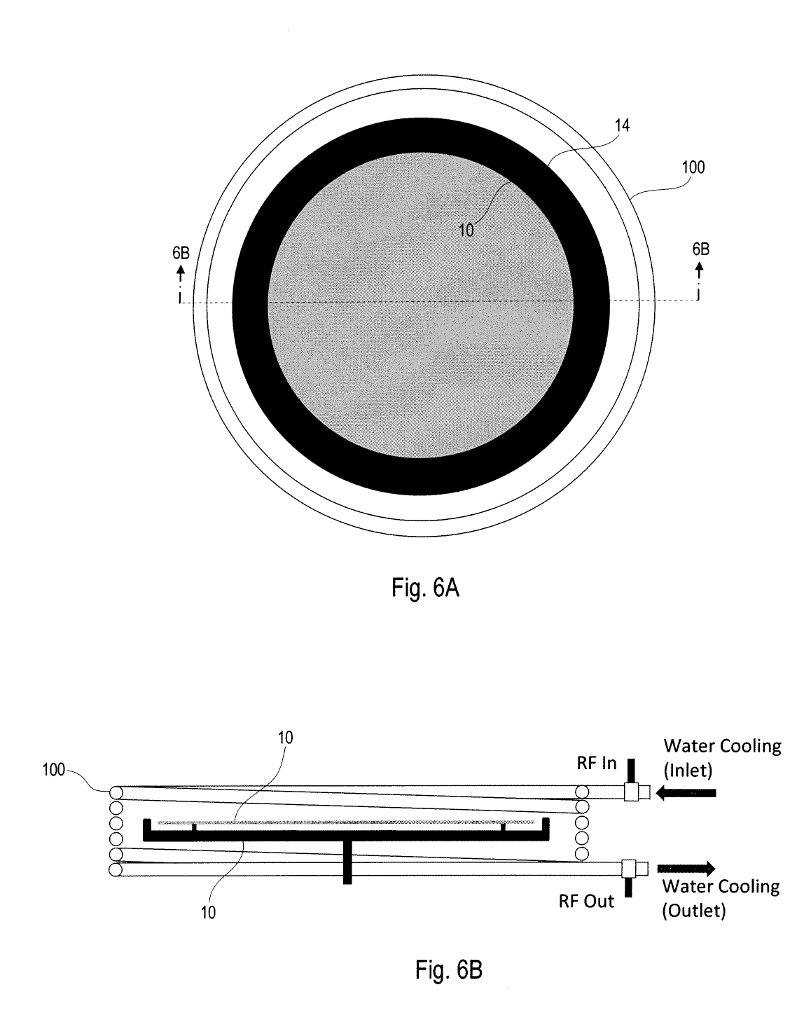

FIG. 6A illustrates a top view a system for processing a substrate, in accordance with an embodiment of the invention. As shown, the RF coil 100 winds around the sides of the susceptor 14. FIG. 6B illustrates a cross-section view of the system, showing the passage of the RF coil 100 around the sides of the susceptor 14. The RF coil is thus open from the top and bottom, enabling easy access to both the substrate 10 and the susceptor 14.

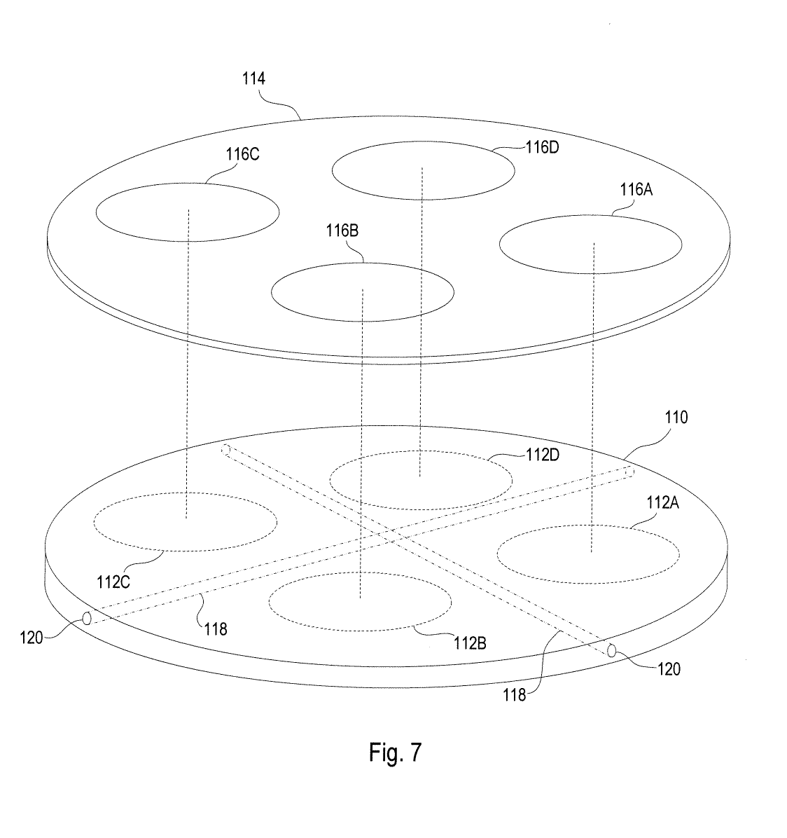

FIG. 7 illustrates a system for processing one or more substrates, in accordance with an embodiment of the invention. As shown, a coil matrix 110 includes four independently controlled RF coils 112A, 112B, 112C, and 112D. Each of the RF coils 112A, 112B, 112C, and 112D, may be formed as planar spiral coils, in accordance with the embodiment of FIG. 2. A susceptor matrix 114 is configured to support four individual susceptors 116A, 116B, 116C, and 116D, which are independently inductively heated by the RF coils 112A, 112B, 112C, and 112D, respectively. Each of the susceptors 116A, 116B, 116C, and 116D may be suspended in the susceptor matrix 114 (e.g. by quartz supports) so as to isolate each of the susceptors from the matrix 114 and from each other. As the susceptors 116A-116D are independently heated, the system may define various independent heating zones so as to provide differential heating to different portions of a substrate which spans the susceptors. Alternatively, smaller individual substrates may be oriented atop each of the susceptors 116A-116D, allowing for simultaneous processing of the individual substrates at different temperature conditions.

The presently described embodiment may further incorporate additional features to enable improved temperature separation between each of the heating zones defined by the susceptors 116A-116D. For example, gas flow may be directed and controlled so as to prevent cross-contamination of gas and temperature between different heating zones. Further, the susceptor matrix 114 may incorporate internal channels 118 for enabling a fluid (liquid or gaseous) to flow through the susceptor matrix 114 which provides for temperature separation between the heating zones by removing heat from the susceptor matrix. In one embodiment, the fluid flows from the interior of the susceptor matrix 114 through the internal channels 118 and exits the susceptor matrix 114 via exhaust ports 120.

In alternative embodiments of the invention, the aforementioned RF coil(s) may act as an inductively coupled plasma generator, generating plasma by inductively causing currents in gases which come into proximity with the magnetic field produced by the RF coil. Thus, systems for processing substrates as described herein may be configured to provide both heating of the substrate as well as plasma generation. In some embodiments, the system is configured to generate inductively coupled plasma simultaneously while also inductively heating the susceptor, for example, by generating and applying heterodyned frequencies.

In some embodiments, the RF coil is situated in the same environment as the susceptor. However, in other embodiments, the RF coil may be separated from the susceptor (for example, by a quartz window), such that the RF coil and susceptor are maintained in different environments. In one embodiment, the system is configured such that the RF coil is maintained at ambient atmospheric temperatures and pressures, whereas the susceptor is contained under vacuum conditions.

While foregoing embodiments of the invention have generally been described in the context of graphene deposition, it will be understood by those skilled in the art that the systems and methods for induction heating as described herein may be applied to any application where heating of a substrate is required. For example, the inductive heating systems described herein may be applied metal-organic chemical vapor deposition (MOCVD) and epitaxy.

The present invention provides greatly improved methods and apparatus for the rapid heating and cooling of substrates during processing. It is to be understood that the above description is intended to be illustrative and not restrictive. Many embodiments and variations of the invention will become apparent to those of skill in the art upon review of this disclosure. Merely by way of example a wide variety of process times, process temperatures and other process conditions may be utilized, as well as a different ordering of certain processing steps. The scope of the invention should, therefore, be determined not with reference to the above description, but instead should be determined with reference to the appended claims along with the full scope of equivalents to which such claims are entitled.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention.

The embodiments described above provide methods and apparatus which are useful for the parallel or rapid serial synthesis, processing and analysis of novel materials having useful properties identified for semiconductor manufacturing processes. Any materials found to possess useful properties can then subsequently be prepared on a larger scale and evaluated in actual processing conditions. These materials can be evaluated along with reaction or processing parameters through the methods described above. In turn, the feedback from the varying of the parameters provides for process optimization. Some reaction parameters which can be varied include, but are not limited to, process material amounts, reactant species, processing temperatures, processing times, processing pressures, processing flow rates, processing powers, processing reagent compositions, the rates at which the reactions are quenched, atmospheres in which the processes are conducted, an order in which materials are deposited, etc. In addition, the methods described above enable the processing and testing of more than one material, more than one processing condition, more than one sequence of processing conditions, more than one process sequence integration flow, and combinations thereof, on a single substrate without the need of consuming multiple substrates per material, processing condition, sequence of operations and processes or any of the combinations thereof. This greatly improves the speed as well as reduces the costs associated with the discovery and optimization of semiconductor manufacturing operations.

Moreover, the embodiments described herein are directed towards delivering precise processing conditions at specific locations of a substrate in order to simulate conventional manufacturing processing operations. Within a region the process conditions are substantially uniform, in contrast to gradient processing techniques which rely on the inherent non-uniformity of the material deposition. That is, the embodiments, described herein locally perform the processing in a conventional manner, e.g., substantially consistent and substantially uniform, while globally over the substrate, the materials, processes and process sequences may vary. It should be noted that the discrete steps of uniform processing is enabled through High Productivity Combinatorial (HPC) systems.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A system for processing a substrate, comprising:
a power source for providing a current;
a coil, the coil generating a magnetic field when supplied with the current;
a susceptor for supporting the substrate, the susceptor being inductively heated by the magnetic field so as to heat the substrate.

2. The system of claim 1, further comprising a lift mechanism for lifting the substrate from the susceptor, the lift mechanism accessing an edge of the substrate via a notch in the susceptor.

3. The system of claim 1, wherein the coil is formed as a planar spiral.

4. The system of claim 1, further comprising a cooling source, the cooling source providing a cooling fluid;
wherein the coil includes an interior channel for enabling the cooling fluid to flow through the coil.

5. The system of claim 1, wherein the susceptor is rotatable.

6. The system of claim 1, wherein a distance between the susceptor and the coil is adjustable.

7. The system of claim 1, wherein a thickness of the susceptor is varied.

8. The system of claim 1, wherein the coil is composed of copper.

9. The system of claim 1, wherein the susceptor includes a material selected from the group consisting of silicon carbide, graphite, tungsten, titanium coated graphite, stainless steel, molybdenum, and Iconel.

10. A system for processing a substrate, comprising:
a susceptor for supporting and heating the substrate;
a radio frequency (RF) coil positioned beneath the susceptor, the RF coil formed as a planar spiral aligned along a plane parallel to a top surface of the susceptor, the RF coil generating a magnetic field when supplied with a current which inductively heats the susceptor so as to heat the substrate, the RF coil including an interior channel for enabling a cooling fluid to flow through the RF coil; and
a lift mechanism for lifting the substrate.

11. The system of claim 10, wherein the susceptor and the RF coil are configured to cool the substrate at a rate greater than about 200 degrees Celsius per minute when the magnetic field is not present.

12. The system of claim 10, wherein the lift mechanism includes at least one lift member extending toward a periphery of the substrate to a position beneath an outer edge of the substrate, the lift member supporting the substrate from the outer edge.

13. The system of claim 10, wherein the RF coil is composed of copper, and a protective coating material selected from the group consisting of nickel, rhodium, and silver.

14. The system of claim 10, wherein the cooling fluid is water.

15. A method of heating and cooling a substrate, comprising:
orienting a substrate atop a susceptor;
generating a magnetic field which inductively heats the susceptor;
transferring the heat from the susceptor to the substrate.

16. The method of claim 15, wherein the magnetic field is generated by applying a current to a coil, the coil being disposed beneath the susceptor, the coil being formed as a planar spiral oriented along a plain parallel to a top surface of the susceptor.

17. The method of claim 16, further comprising:
flowing a cooling fluid through an interior channel of the coil so as to cool the coil, the susceptor, and the substrate.

18. The method of claim 16, further comprising:
adjusting a distance between the susceptor and the coil so as to promote inductive heating of the susceptor without causing substantial inductive heating of the substrate.

19. The method of claim 16, further comprising:
terminating the current to halt the inductive heating of the susceptor; and
cooling the substrate through the coil at a rate greater than about 200 degrees Celsius per minute.

20. The method of claim 15, wherein the susceptor enables uniform inductive heating by compensating for non-uniform distribution of the magnetic field across the susceptor.
